(19) United States
(12) Patent Application Publication
(10) Pub. No.: US 2009/0132510 A1
(43) Pub. Date: May 21, 2009

(54) DEVICE FOR ENABLING TO REPRESENT CONTENT ITEMS THROUGH META SUMMARY DATA, AND METHOD THEREOF

(75) Inventors: NEVENKA DIMITROVA, PELHAM MANOR, NY (US); LALITHA AGNIHOTRI, TARRYTOWN, NY (US); MAURO BARBIERI, Eindhoven (NL)

Correspondence Address: GRADY K. BERGEN, 3333 LEE PARKWAY, SUITE 600, DALLAS, TX, 75219, US

(73) Assignee: KONINKLIJKE PHILIPS ELECTRONICS, N.V., EINDHOVEN (NL)

(21) Appl. No.: 11/917,165

(22) PCT Filed: Jun. 12, 2006
(86) PCT No.: PCT/IB2006/051857

§ 371 Date: Dec. 11, 2007

(30) Foreign Application Priority Data
Jun. 15, 2005 (EP) 05105253.8

(51) Int. Cl. G06F 7/06; G06F 17/30

(52) U.S. Cl. 707/5; 707/E17.014

(57) ABSTRACT

The invention relates to a method of enabling to represent content items, the method comprising a step of obtaining a plurality of content item summary data of a respective one of the content items. The invention also relates to a device (210) for enabling to represent content items. The method comprises steps of—(HO) obtaining a plurality of content item summary data of a respective one of the content items, (130) determining a rating of each content item summary data, (140) selecting, from the plurality of the content item summary data, at least one further content item summary data on the basis of the respective rating, and—(150) enabling to generate meta summary data including the at least one further content item summary data.

The invention relates to a method of enabling to represent content items, the method comprising a step of obtaining a plurality of content item summary data of a respective one of the content items. The invention also relates to a device for enabling to represent content items.

A generation of a video summary to provide an overview of a collection of TV programs is known from an article “Multimedia content analysis: The next wave”, N. Dimitrova, in Proc. of the 2nd Conference on Image and Video Retrieval, pages 9-18, Illinois, USA, August 2003. Each program is individually analysed and the video summary for each program is generated. However, the number of the video summaries of a large collection of the TV programs will be very large. It would take a significant amount of time to view such a collection of video summaries. Therefore, the summaries generated in the known manner are cumbersome and not easy to use.

It is desirable to provide a method of representing content items, which allows to generate video summaries which are easy and compact, even when the number of the content items is large.

The method of the present invention comprises steps of

obtaining a plurality of content item summary data of a respective one of the content items,

determining a rating of each content item summary data,

selecting, from the plurality of the content item summary data, at least one further content item summary data on the basis of the respective rating, and

enabling to generate meta summary data including the at least one further content item summary data.

The content items may be television programs recorded by a video recorder, video content stored on a data carrier such as a DVD disk, etc. The content item may be summarised by applying a content analysis method, e.g., a key-frame extraction method; and by compiling a sequence of most significant parts (e.g., key-frames) of the content item, by generating a text description of the most significant parts, or the like. Alternatively, the content item summary data of all or some of the content items are obtained without performing the actual summarisation of the content items. For instance, the content item summary data are downloaded from the Internet.

The content item summary data are rated to determine the most important information (e.g., an event) among the data. The rating may be carried out in various manners. For instance, a frequency of an occurrence of a particular news event in the summary data of all content items is determined. For example, keywords (related to the event) found in first content item summary data are used to identify the number of second summary data containing the same or similar keywords. The frequency may serve as an indication of the importance of the information, and it may be used to determine the rating of the particular summary data. In another example, the rating may also be influenced by a duration or size of the content item summary data of a TV news program. The important TV news program may result in a lot of summary data since the TV news programs are longer themselves if they are important. However, the rating may be done using different criteria depending on a genre of a content item. For instance, criteria applicable to TV news program summary data may not be useful for movie summary data. It should be noted that if the rating is performed on the available summary data, the rating process is faster than when an analysis of the actual content items to derive ratings of content items.

To reduce the amount of information presented by the plurality of the content item information data, a selection is performed among the content item summary data on the basis of the respective rating. For example, the content item summary data, having the rating higher than a particular threshold, is selected. The selection process allows to filter only most important information out the plurality of the content item summary data. The selection results in that a set of further content item summary data is filtered out. Depending on the selection method, e.g., an adjustable level of the threshold, the set of further content item summary data may have an amount of data which is respectively smaller than of the initial plurality of the content item summary data.

The further content item summary data may be used to generate meta summary data in the form of a video slide show with summaries of important content items, or a list of textual summaries with links to corresponding content items, etc.

The device of the present invention comprises a data processor configured to
obtain a plurality of content item summary data of a respective one of the content items,
determine a rating of each content item summary data,
select, from the plurality of the content item summary data, at least one further content item summary data on the basis of the respective rating, and
enable to generate meta summary data including the at least one further content item summary data.

For instance, the device may be an Internet server suitably configured to perform the steps of the method of the present invention. In one embodiment, the server may not generate the content item summary data but it may receive the content item summary data from another apparatus via the Internet.

These and other aspects of the invention will be further explained and described, by way of example, with reference to the following drawings:

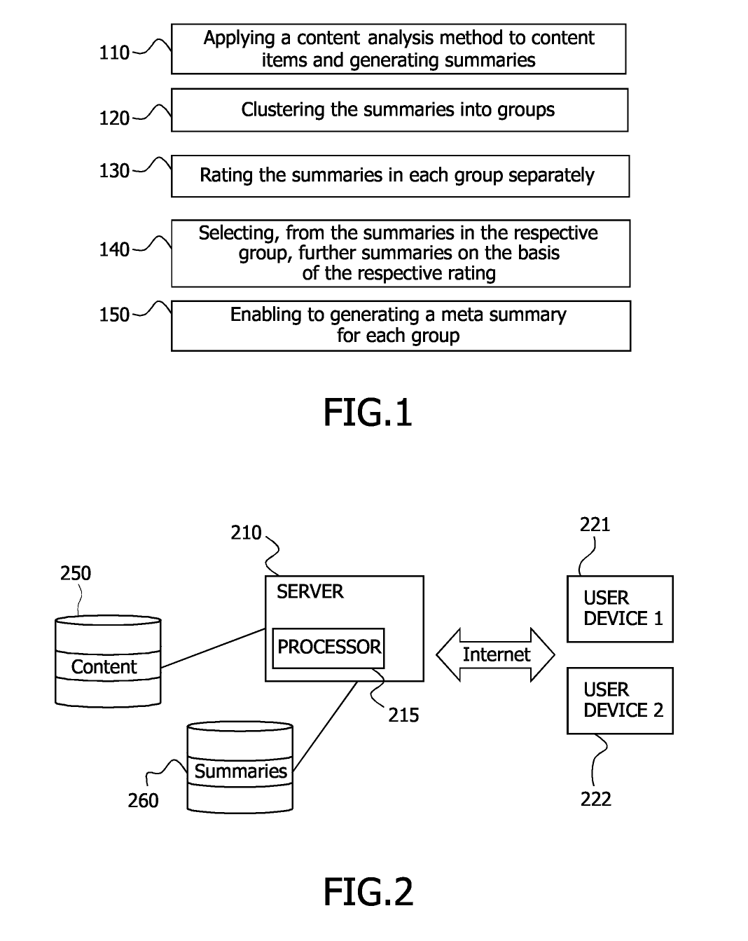

FIG. 1 is an embodiment of the method of the present invention;

FIG. 2 is a functional block diagram of an embodiment of the device according to the present invention.

Content summarisation involves a process of condensing media content into a shorter descriptive form of the original media content.

The media content or content item may comprise at least one of, or any combination of, visual information (e.g., video images, photos, graphics), audio information, and other digital data such, e.g., meta-data according to the MPEG-7 standard which may be used to describe and search digitized materials by means of sampling, as well as by using lexical search terms. The expression “audio content” (or “audio data”) is hereinafter used as data pertaining to audio comprising audible tones, silence, speech, music, tranquility, external noise or the like. The audio data may be in formats like the MPEG-1 layer II (mp3) standard (Moving Picture Experts Group), AVI (Audio Video Interleave) format, WMA (Windows Media Audio) format, etc. The expression “video content” (or “video data”) is used as data which are visible such as a motion picture, “still pictures”, video text etc. The video data may be in formats like GIF (Graphic Interchange Format), JPEG (named after the Joint Photographic Experts Group), MPEG-4, etc. The meta-data may be in the XML (Extensible Markup Language) format, MPEG7 format, stored in a SQL database or any other format.

The content summarisation of a single content item may be performed in various manners, e.g., by generating a video skim or video highlights sequence. The content summarisation of the content item results in a generation of content item summary data (further referred to as “summary data”, e.g., if the content summarisation of a single content item is meant). The summary data may comprise a still picture extracted from the content item, a segment of the content item, e.g., a video clip, textual summary generated by applying a speech recognition method to the content item, a link to a particular segment of the content item which is considered to be important, etc. The summary data may comprise solely or a combination of the audio data and the video data.

An embodiment of the method of the present invention is shown in FIG. 1. In step 110, a content analysis method is applied to analyse the content item. The content items may be processed independently and the generation of the summary data may be individual for each content item. The step 110 is optional and it may be skipped in case the summary data for one or more content items are already available, e.g., via the Internet or from a database of summary data of content items.

The generation of the summary data may be carried out automatically in many ways. For instance, one method of a video summary generation is known from an article “Video Manga: Generating Semantically Meaningful Video Summaries”, Shingo Uchihashi, Jonathan Foote, Andreas Girgensohn, and John Boreczky, In Proceedings ACM Multimedia, (Orlando, Fla.) ACM Press, pp. 383-392, 1999, Oct. 30, 1999. The method relies on a key-frame extraction by clustering video frames of a video content (into segments) on the basis of a similarity measure between the video frames, regardless of a temporal continuity of the video frames. The similarity is measured by comparing three dimensional colour histograms of the video frames in the YUV colour space. The clusters of the similar video frames are emphasised or discarded depending on a calculated importance score of each cluster. The importance score of the cluster is based on a frequency of the cluster in the video content and duration of the video segment. The cluster is deemed to be less important if the cluster is short or very similar to other clusters. Clusters with an importance score higher than a threshold are selected to generate a pictorial summary of the video content item. A key frame is extracted from each cluster with the high importance value. A frame nearest to the centre of the cluster is selected as the key frame.

In step 120, the content item summary data are clustered into one or more groups. The groups may be formed depending on a genre (e.g., comedy, sport, fiction, etc.), topic (Election of Pop in Vatican, Tsunami disaster, etc.), or another attribute characterizing the content items. For instance, summary data of sport TV programs are clustered separately from summary data of movie TV programs. It is known in the TV broadcasting to include data indicating the attribute, e.g., the genre, into a broadcast TV signal. Alternatively, it is possible to detect the genre or another attribute of a content item by applying automatic genre detectors to the content item.

Alternatively, the groups are formed in step 120 by detecting similarity between the content item summary data, and not between the respective original content items. The original content items may simply not be available. Different techniques may be used for calculating a similarity value between the content item summary data. For instance, if different summary data include textual descriptions of respective content items, the similarity value may be determined by counting an amount of repeating keywords in the summary data. In another example, the similarity value between the summary data is determined on the basis of a presence of the same or similar video objects, e.g., a particular character (actor or the like), or similar video patterns, e.g., fast moving cars, etc. In fact, the clustering on the basis of the summary data is faster than the clustering on the basis of the original content items, e.g., because less audio data and/or video data is processed.

In step 130, the content item summary data within one group are rated independently of the content item summary data from another group. However, the rating of the summary data may also be carried out without the clustering of the summary data in step 120. When the summary data are rated within one group only, the process of rating may be more accurate and reliable than when the summary data are rated without regard to the genre, topic, etc. of the summary data. The accuracy and quality is achieved by applying, to a particular group of the summary data having a respective specific attribute, a rating algorithm which is specifically adapted for rating the summary data having the specific attribute. Correspondingly, a plurality of these specialised rating algorithms may be required to rate accurately corresponding groups of the summary data having the respective specific attributes. A use of a generic rating algorithm for the summary data associated with various attributes is also possible, but the results of the rating may not be the same precise as when the specialised rating algorithms are used.

The process of rating the summary data is not necessarily related to the manner of generating the summary data. The summary data may be rated in various ways. For instance, a distribution of a frequency of occurrence of words, phrases, video objects, etc. in the summary data is determined. The frequency distribution may indicate which summary data within one group is the most closely related to a predetermined reference model of the frequency distribution for typical known important summaries. For example, it may be predetermined that important summaries have a particular lowest number of particular summary elements. In soccer programs, the important games are often filmed with some multiple repetitions of goals. As an example, a video record of a good soccer game has a lot of video scenes with a goal into gates of a popular soccer team. The summary data for such a soccer video record would have a large number of video frames with this type of scenes. Therefore, such summary data would be rated high. Other criteria may be used as the basis for determining the rating of the summary data. The criteria will generally relate to a level of an importance of the respective one of the plurality of the content item summary data.

It should be mentioned that, when the summary data are rated in each group independently, a set of possible values of the rating of the summary data may be different for the groups. For example, the summary data related to sport can be rated as “professional”, “amateur”, etc., whereas the summary data for news programs can be rated as “hot news”, “regular news”, etc. Such differing rating schemes for respective groups of the summary data may further be mapped on more standardised values like “high”, “average” and “low”. The mapping may vary and allow some freedom of interpretation and personal preferences. The mapping may even be personalised on the basis of preferences of consumers (users of consumer electronics devices). For instance, the consumers may have different views on what has high importance in summary data of content items with different genres.

In step 140, only content item summary data with a high rating is further selected from all rated summary data. For instance, the rating may have one of values A (high), B (average) or C (low), and only the summary data with the rating A are selected while the other summary data are further discarded. One or more of further content item summary data are filtered out of all available content item summary data. Thus, only most important summary data are further taken into account. In one embodiment, the further content item summary data is/are selected from a respective one of the groups of the content item summary data.

The selection of the further content item summary data enables a generation of meta summary data. Basically, the meta summary data is a next level summary data. In step 150, for instance, one or more further content item summary data may be combined/ordered into a sequence by taking into account when respective content items were broadcast. This would allow a logical overview of the important content items in a chronological order.

FIG. 2 is an embodiment of the device of the present invention. The device may be implemented in many possible variations. For instance, the device may be incorporated in a video recorder for recording video content or an audio player for play back audio content. In the embodiment shown in FIG. 2, the device 210 is incorporated in a server apparatus for communicating, e.g., via the Internet, with one or more user devices 221 and 222, such as the video recorder, the audio player or any other consumer electronics appliances.

The device 210 comprises a data processor 215 for obtaining a plurality of content item summary data. In one implementation, the data processor 210 is configured to access a (remote or local) content item database 250 that stores a plurality of content items. The data processor may receive the content items and apply a content analysis method to generate content item summary data of a respective content item. The generation of the content item summary data may be performed as it is described above with reference to step 110.

In another implementation, the data processor 215 does not process the content items, but simply receives the content item summary data from a (remote or local) database 260 of the summary data of the content items. For instance, the user device 221 or 222, e.g., a TV set-top box with a HDD drive, is adapted to automatically record many hours of TV programs in the course of many days. At a certain moment, the user device may, automatically or upon a user command, generate a request for the condense meta summary data of these recorded TV programs rather than for the plurality of content item summary data. The user device 221 or 222 may communicate the request to the remote data processor 215. The request may comprise only a list of the content items recorded by the user device. The list may include a title of a particular content item, a TV channel that broadcasted the content item, a time of the broadcast, etc. Further, the data processor 215 performs the generation of the meta summary data as it is described with reference to steps 110-150 in FIG. 1.

The data processor 215 may be a well-known central processing unit (CPU) suitably arranged to implement the present invention and enable the operation of the device 210 as explained herein. The device 210 may additionally comprise a memory module (not shown), for example, a known RAM (random access memory) memory module. The data processor 215 may be arranged to read from the memory module at least one instruction to enable the functioning of the device.

A “computer program” is to be understood to mean any software product stored on a computer-readable medium, such as a floppy disk, downloadable via a network, such as the Internet, or marketable in any other manner. The invention can be implemented by means of hardware comprising several distinct elements, and by means of a suitably programmed computer.

Variations and modifications of the described embodiment are possible within the scope of the inventive concept. The data processor may execute a software program to enable the execution of the steps of the method of the present invention. The software may enable the device of the present invention independently of where it is being run. To enable the device, the data processor may transmit the software program to the other (external) devices, for example. The independent method claim and the computer program claim may be used to protect the invention when the software is manufactured or exploited for running on the consumer electronics products. The external device may be connected to the processor using existing technologies, such as Blue-tooth, IEEE 802.11[a-g], etc. The data processor may interact with the external device in accordance with the UPnP (Universal Plug and Play) standard.

1. A method of enabling to represent content items, comprising:
obtaining a plurality of content item summary data of a respective one of the content items;
determining a rating of each content item summary data;
selecting, from the plurality of the content item summary data, at least one further content item summary data on the basis of the respective rating; and
enabling to generate meta summary data including the at least one further content item summary data.

2. The method of claim 1, further comprising, in order to obtain the plurality of content item summary data, proessing at least one of the content items and generating respective at least one of the plurality of the content item summary data.

3. The method of claim 1, further comprising clustering the plurality of content item summary data into one or more groups if respective content items have the same attribute characterizing the content items.

4. The method of claim 3, wherein the obtaining, determining, selecting, enabling and clustering are independently performed for a respective one of the groups of content item summary dataz: in order to generate a plurality of meta summary data for the respective groups.

5. The method of claim 4, further comprising merging the plurality of meta summary data into a multi-attribute meta summary data.

6. The method of claim 1, wherein the content items have broadcast times, and the further content item summary data are included in the meta summary data by taking into account the broadcast times of the respective content items.

7. The method of claim 1, wherein the rating is determined on the basis of a criterion related to an importance of the respective one of the content items or of the respective one of the plurality of content item summary data.

8. The method of claim 1, wherein the rating is dependent on a genre of the respective content item.

9. A device for enabling to represent content items, the device comprising a data processor configured to
obtain a plurality of content item summary data of a respective one of the content items,
determine a rating of each content item summary data,
select, from the plurality of the content item summary data, at least one further content item summary data on the basis of the respective rating, and
enable to generate meta summary data including the at least one further content item summary data.

10. (canceled)

11. A computer readable storage medium containing software instructions which, when executed, perform the acts comprising:
obtaining a plurality of content item summary data of a respective one of the content items;
determining a rating of each content item summary data;
selecting, from the plurality of the content item summary data, at least one further content item summary data on the basis of the respective rating; and
enabling to generate meta summary data including the at least one further content item summary data.
